(19) United States
(12) Patent Application Publication
(10) Pub. No.: US 2022/0017244 A1
(43) Pub. Date: Jan. 20, 2022

(54) SYSTEM AND METHOD OF PACKAGING A FOODSTUFF INGREDIENT INTO DISCRETE QUANTITIES

(71) Applicant: Hannah Lynnette Yow, Mount Pleasant, TX (US)

(72) Inventor: Hannah Lynnette Yow, Mount Pleasant, TX (US)

(21) Appl. No.: 17/379,995

(22) Filed: Jul. 19, 2021

Related U.S. Application Data
(60) Provisional application No. 63/053,464, filed on Jul. 17, 2020.

(51) Int. Cl. B65B 1/04; B65B 29/00; B65B 61/26; B65C 5/00; B65B 69/00; B65B 51/10

(52) U.S. Cl. CPC B65B 1/04; B65B 29/00; B65B 61/26; B65B 2220/16; B65B 69/00; B65B 51/10; B65C 5/00

(57) ABSTRACT

A system and a method of packaging a foodstuff ingredient into discrete quantities facilitate the preparation for baking and cooking. The system includes a bulk quantity of foodstuff ingredient, a plurality of single-use packages, and a recipe with a foodstuff-ingredient requirement. The method begins by filling each single-use package with a corresponding quantity of foodstuff ingredient through an open end of the single-use package. Moreover, a corresponding quantity of foodstuff ingredient is equal to the specific volumetric capacity of each single-use package. The open end of each single-use package is then closed. Each single-use package is labeled with a description of the corresponding quantity of foodstuff ingredient. The open end of a specific single-use package is then reopened, wherein the corresponding quantity of foodstuff for the specific single-use package meets the food-stuff ingredient requirement. The corresponding quantity of foodstuff ingredient is dispensed out of the open end.

The current application claims a priority to the U.S. Provisional Patent application Ser. No. 63/053,464 filed on Jul. 17, 2020. The current application is filed on Jul. 19, 2021 while Jul. 17, 2021 was on a weekend.

### FIELD OF THE INVENTION

The present invention generally relates to baking and cooking. More specifically, the present invention packages a foodstuff ingredient into discrete quantities.

### BACKGROUND OF THE INVENTION

The present invention provides single-use sugar and flour products. Often one must measure various ingredients when preparing a meal, baked goods, etc. However, measuring and separating ingredients can be a time-consuming task as many recipes require precise measurements of multiple ingredients. Further, measuring ingredients can be a hassle for many without the right tools resulting in wrong measurements and possibly ruined recipes.

An objective of the present invention is to provide pre-packaged measured ingredients for a fresh, pre-measured, ready-to-use way for the consumer to get their recipe supplies ready without having to manually measure the individual ingredients. The present invention provides commonly used recipe ingredients measured in predetermined amounts (i.e., 1 cup, ½ cup, and/or ¼ cup measured amounts) in one package. The consumer can conveniently open a fresh bag of the exact amount of ingredients the recipe calls for without having to measure the individual ingredients. Having the necessary ingredients already measured out and ready to use saves preparation time for the consumer. Further, the consumer will not have to worry about any unused ingredients getting stale over time. The pre-packaged measured ingredients are exposed to the environment only when the consumer opens the package. It will be in the freshest and most convenient form available, making the present invention suitable for other applications such as home delivery meal kits. Other features and additional benefits are further discussed in the sections below.

### BRIEF DESCRIPTION OF THE DRAWINGS

FIG. 1 is a schematic view illustrating a system for a method of the present invention.

FIG. 2 is a flowchart illustrating the overall process for a method of the present invention.

FIG. 3 is a flowchart illustrating a continuation of the overall process for a method of the present invention.

FIG. 4 is a flowchart illustrating the subprocess of storing the plurality of single-use packages within a resealable bag for a method of the present invention.

FIG. 5 is a flowchart illustrating the subprocess of heat sealing the open end of each single-use package.

### DETAIL DESCRIPTIONS OF THE INVENTION

All illustrations of the drawings are for the purpose of describing selected versions of the present invention and are not intended to limit the scope of the present invention.

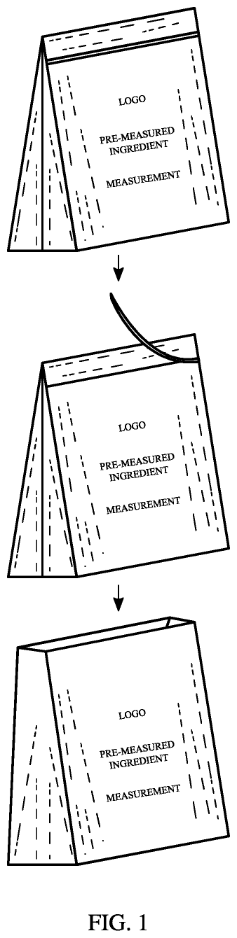

The present invention is a system and method of packaging a foodstuff ingredient into discrete quantities. The present invention facilitates the preparation process for baking and cooking. More specifically, a user does not have to manually measure individual ingredients. Furthermore, the present invention preserves the freshness of ingredients. Thus, the physical system used to implement the method for the present invention includes a bulk quantity of foodstuff ingredient and a plurality of single-use packages, wherein each single-use package comprises an open end and a closed end (Step A), seen in FIG. 1. The bulk quantity of foodstuff ingredient is a baking ingredient or cooking ingredient needed to bake or cook a dish. The plurality of single-use packages contains and houses the bulk quantity of foodstuff ingredient. The open end provides an exit for the bulk quantity of foodstuff ingredient through each single-use package. The closed end surrounds the bulk quantity of foodstuff ingredient.

Moreover, each single-use package is dimensioned with a specific volumetric capacity, wherein the specific volumetric capacity of each single-use package is different amongst each other. The specific volumetric capacity is a defined volume of how much foodstuff ingredient can be retained within each single-use package. The specific volumetric capacity is selected from a group consisting of: 0.25 teaspoon, 0.5 teaspoon, 1 teaspoon, 0.25 tablespoon, 0.5 tablespoon, 1 tablespoon, 0.25 cup, 0.5 cup, 0.75 cup, and 1 cup, and this group in English measurements includes standard requirements for successfully baking and cooking a dish. Alternatively, the specific volumetric capacity may also be selected from a group consisting of: 5 milliliters, 15 milliliters, 30 milliliters, 60 milliliters, 80 milliliters, 125 milliliters, 160 milliliters, 180 milliliters, and 250 milliliters, and this group in Metric measurements similarly includes standard requirements for successfully baking and cooking a dish. In a first embodiment of the present invention, the bulk quantity of foodstuff ingredient is sugar, and, in a second embodiment of the present invention, the bulk quantity of foodstuff ingredient is flour. This is because sugar and flour are common ingredients for baked dishes and cooked dishes. The sugar may be, but is not limited to, cane sugar, organic sugars, coconut sugar, and sugar substitutes. The flour may be, but is not limited to, organic flour, wheat flour, coconut flour, gluten-free flour, and almond flour.

In order to contain various foodstuff ingredients, the structure of each single-use package may vary. A package body of each single-use package tapers from the closed end to the open end such that the bulk quantity of foodstuff easily and effectively exits the open end and into a bakeware or cookware such as a mixing bowl or pot. In order to better manage a foodstuff ingredient that does not maintain a rigid form, the closed end is a flat base in some embodiments, and the open end is a spout in some embodiments.

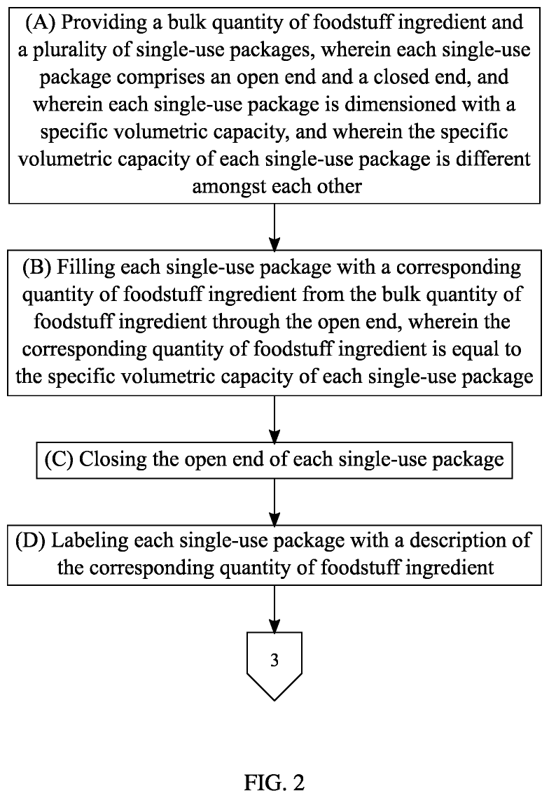

The overall process for the method of the present invention includes the following steps that are implemented with the bulk quantity of foodstuff ingredient and the plurality of single-use packages. The method begins by filling each single-use package with a corresponding quantity of foodstuff ingredient from the bulk quantity of foodstuff ingredient through the open end, wherein the corresponding quantity of foodstuff ingredient is equal to the specific volumetric capacity of each single-use package (Step B), seen in FIG. 2. Each single-use package is therefore able to provide a corresponding quantity of foodstuff ingredient for a user. Furthermore, the corresponding quantity of food stuff ingredient is securely housed within the single-use package and does not slip and slide within the single-use package. The open end of each single-use package is then closed (Step C), thereby preserving the freshness of the corresponding quantity of foodstuff ingredient. In order for the user to be made aware of the value of the corresponding quantity of foodstuff ingredient, each single-use package is labeled with a description of the corresponding quantity of foodstuff ingredient (Step D). The description of the corresponding quantity of foodstuff ingredient preferably includes the name of the corresponding quantity of foodstuff ingredient and the amount of the corresponding quantity of foodstuff ingredient.

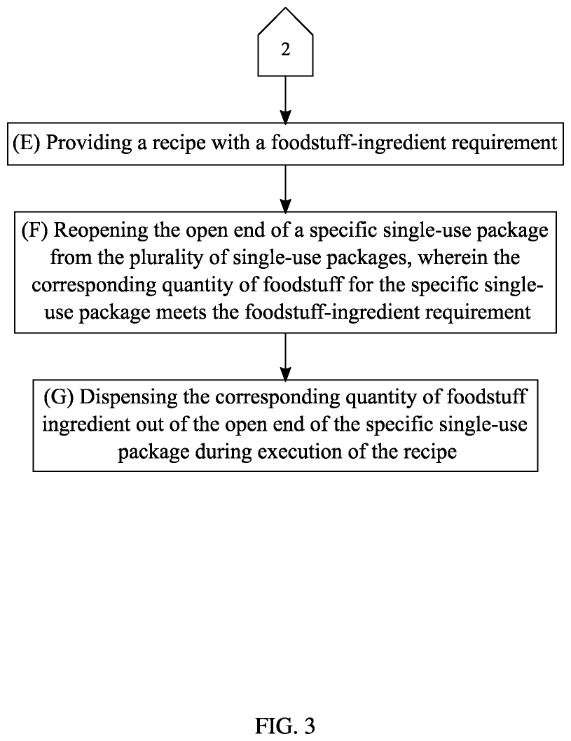

The overall process continues as a recipe that is ready to be prepared by a user includes a foodstuff-ingredient requirement (Step E), seen in FIG. 3. The recipe provides the user with a list of required ingredients and a set of steps to effectively produce a baked good or a cooked dish, wherein each required ingredient is a foodstuff-ingredient requirement and has both a name of the ingredient and an amount for the ingredient. In order for a user to access the corresponding quantity of foodstuff ingredient, the open end of a specific single-use package is reopened from the plurality of single-use packages, wherein the corresponding quantity of foodstuff ingredient for the specific single-use package meets the foodstuff-ingredient requirement (Step F). The corresponding quantity of foodstuff ingredient is dispensed out of the open end of the specific single-use package during execution of the recipe (Step G), thereby utilizing the corresponding quantity of foodstuff ingredient according to the recipe.

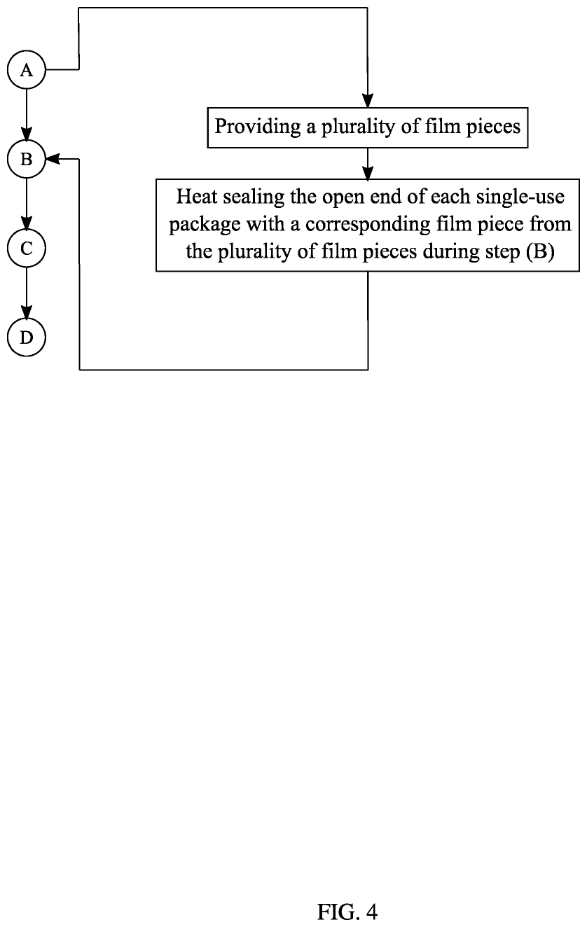

In further embodiments of the invention, a resealable bag is provided for the system of the present invention, seen in FIG. 4. The resealable bag houses the plurality of single-use packages to maintain organization within a cabinet or pantry. The plurality of single-use packages is stored within the resealable bag after Step D so that a user may easily locate and access the plurality of single-use packages within the resealable bag when needed.

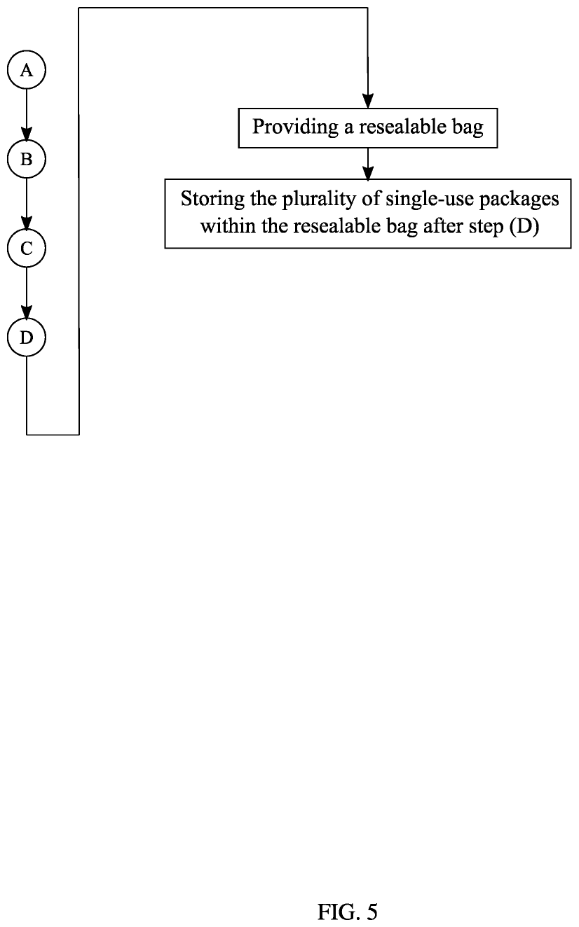

In another embodiment of the present invention, a plurality of film pieces is provided for the system of the present invention in order to heat seal the open end of a single-use package, seen in FIG. 5. The open end of each single-use package is heat sealed with a corresponding film piece from the plurality of film pieces during Step B to securely lock and preserve the freshness for the corresponding quantity of foodstuff ingredient.

Although the invention has been explained in relation to its preferred embodiment, it is to be understood that many other possible modifications and variations can be made without departing from the spirit and scope of the invention as hereinafter claimed.

What is claimed is:

1. A method of packaging a foodstuff ingredient into discrete quantities, the method comprising the steps of:
(A) providing a bulk quantity of foodstuff ingredient and a plurality of single-use packages, wherein each single-use package comprises an open end and a closed end, and wherein each single-use package is dimensioned with a specific volumetric capacity, and wherein the specific volumetric capacity of each single-use package is different amongst each other;
(B) filling each single-use package with a corresponding quantity of foodstuff ingredient from the bulk quantity of foodstuff ingredient through the open end, wherein the corresponding quantity of foodstuff ingredient is equal to the specific volumetric capacity of each single-use package;
(C) closing the open end of each single-use package; and,
(D) labeling each single-use package with a description of the corresponding quantity of foodstuff ingredient.

2. The method of packaging a foodstuff ingredient into discrete quantities, the method as claimed in claim 1 comprising the steps of:
(E) providing a recipe with a foodstuff-ingredient requirement;
(F) reopening the open end of a specific single-use package from the plurality of single-use packages, wherein the corresponding quantity of foodstuff for the specific single-use package meets the foodstuff-ingredient requirement; and,
(G) dispensing the corresponding quantity of foodstuff ingredient out of the open end of the specific single-use package during execution of the recipe.

3. The method of packaging a foodstuff ingredient into discrete quantities, the method as claimed in claim 1 comprising the steps of:
providing a resealable bag; and,
storing the plurality of single-use packages within the resealable bag after step (D).

4. The method of packaging a foodstuff ingredient into discrete quantities, the method as claimed in claim 1 comprising the steps of:
providing a plurality of film pieces; and,
heat sealing the open end of each single-use package with a corresponding film piece from the plurality of film pieces during step (B).

5. The method of packaging a foodstuff ingredient into discrete quantities, the method as claimed in claim 1, wherein the bulk quantity of foodstuff ingredient is sugar.

6. The method of packaging a foodstuff ingredient into discrete quantities, the method as claimed in claim 1, wherein the bulk quantity of foodstuff ingredient is flour.

7. The method of packaging a foodstuff ingredient into discrete quantities, the method as claimed in claim 1, wherein the specific volumetric capacity is selected from a group consisting of: 0.25 teaspoon, 0.5 teaspoon, 1 teaspoon, 0.25 tablespoon, 0.5 tablespoon, 1 tablespoon, 0.25 cup, 0.5 cup, 0.75 cup, and 1 cup.

8. The method of packaging a foodstuff ingredient into discrete quantities, the method as claimed in claim 1, wherein the specific volumetric capacity is selected from a group consisting of: 5 milliliters, 15 milliliters, 30 milliliters, 60 milliliters, 80 milliliters, 125 milliliters, 160 milliliters, 180 milliliters, and 250 milliliters.

9. The method of packaging a foodstuff ingredient into discrete quantities, the method as claimed in claim 1, wherein a package body of each single-use package tapers from the closed end to the open end.

10. The method of packaging a foodstuff ingredient into discrete quantities, the method as claimed in claim 1, wherein the closed end is a flat base.

11. The method of packaging a foodstuff ingredient into discrete quantities, the method as claimed in claim 1, wherein the open end is a spout.
